(19) United States
(12) Patent Application Publication
(10) Pub. No.: US 2024/0098511 A1
(43) Pub. Date: Mar. 21, 2024

(54) EVALUATION METHOD AND INFORMATION PROCESSING APPARATUS

(71) Applicant: Fujitsu Limited, Kawasaki-shi (JP)

(72) Inventors: Natsuki ISHIKAWA, Yamato (JP); Hayato DAN, Yokohama (JP); Yoshihiro OKAWA, Yokohama (JP); Masatoshi OGAWA, Zama (JP)

(73) Assignee: Fujitsu Limited, Kawasaki-shi (JP)

(21) Appl. No.: 18/218,603

(22) Filed: Jul. 6, 2023

(30) Foreign Application Priority Data
Sep. 21, 2022 (JP) 2022-150567

(51) Int. Cl. H04W 16/18; H04W 24/02

(52) U.S. Cl. CPC H04W 16/18; H04W 24/02

(57) ABSTRACT

A non-transitory computer-readable recording medium stores a program for causing a computer to execute a process, the process includes obtaining a third matrix by changing at least one of a position of a target object already installed or a scale of the target object in a two-dimensional second matrix, obtaining three-dimensional second data by superimposing a two-dimensional first matrix and the third matrix, the first matrix being provided for each facility already installed and indicating a position and a scale thereof, and predicting a degree of influence of the target object by inputting the second data, a type of day of week, and time to a machine learning model trained with three-dimensional first data, a type of day of week, and time as input, and with a degree of influence of the target object as output, the first data being obtained by superimposing the first matrix and the second matrix.

### CROSS-REFERENCE TO RELATED APPLICATION

This application is based upon and claims the benefit of priority of the prior Japanese Patent Application No. 2022-150567, filed on Sep. 21, 2022, the entire contents of which are incorporated herein by reference.

### FIELD

The embodiment discussed herein is related to an evaluation method and an information processing apparatus.

### BACKGROUND

It is desired to evaluate and optimize the number, positions, and capacities of target objects providing a service according to the number and positions of users. Here, description will be given for a case in which a base station (BS) in a radio access network (RAN) is a target object and installation of the base station is evaluated. In the following description, a base station is referred to as a “BS”. User equipment that uses a BS is referred to as “UE”.

While it is important to install BSs so as to satisfy the traffic demand of each piece of UE in setting and operation of a RAN, excessive installation of BSs leads to interference of radio waves and an increase in power consumption.

For example, in Shannon's theorem, channel capacity C [bit/s] is defined as in formula (1). In formula (1), “B” is a bandwidth [Hz]. “S” is the total power of signal. “N” is the total power of noise. “I” is the total power of interference. By calculating the channel capacity of each area, it is possible to evaluate whether the traffic demand of each area is satisfied.

$$C = B {log}_{2} ( 1 + \frac{S}{N + I} ) \qquad ( 1 )$$

In order to calculate a channel capacity using Shannon's theorem, for each area, there has to be a calculation formula for the degree of attenuation of a radio wave according to the number of pieces of UE, a relative positional relationship between UE and a BS, and rough regional division. However, it is difficult to assume the number of pieces of UE and a relative positional relationship between UE and a BS for each area.

There is related art in which the number of BSs to be operated in order to satisfy the traffic demand in a target area is estimated by using a neural network (NN) instead of Shannon's theorem. Input of an NN used in such related art is the number of points of interest (POI), the number of BSs, and the number of tweets of a social networking service (SNS) in an area, and output of the NN is a communication capacity of the area.

POI indicates a category or a type of a point displayed on a map. For example, library, cafe, and park are examples of POI. In related art, the maximum value of actual values of traffic data in each area is used as the communication capacity of an area, and used for machine learning of an NN.

In related art, a relationship between BS density and communication capacity is obtained by predicting a communication capacity by changing only the number of BSs among the number of POIs, the number of BSs, and the number of tweets of an SNS which are input to an NN, and an excess or deficiency of the number of BSs with respect to a traffic demand is evaluated. A BS density corresponds to the number of BSs in an area.

FIG. 13 is a diagram illustrating a relationship between BS density and communication capacity obtained in related art. The horizontal axis of graph G1 illustrated in FIG. 13 corresponds to BS density, and the vertical axis corresponds to communication capacity. For example, in an area where the number of BSs is excessive, an energy saving measure may be performed in which a BS is set to a sleep mode.

Japanese Laid-open Patent Publication No. 2007-68163, U.S. Patent Application Publication No. 2021/0014487, Japanese Laid-open Patent Publication No. 2021-78096, Japanese Laid-open Patent Publication No. 2019-161341, and Japanese National Publication of International Patent Application No. 2021-530821 are disclosed as related art.

### SUMMARY

According to an aspect of the embodiment, a non-transitory computer-readable recording medium stores a program for causing a computer to execute a process, the process includes obtaining a third matrix by changing at least one of a position of a target object already installed in a target area or a scale of the target object in a two-dimensional second matrix that indicates the position of the target object and the scale of the target object, obtaining three-dimensional second data by superimposing a two-dimensional first matrix and the third matrix, the first matrix being provided for each facility already installed in the target area and indicating a position of a relevant facility and a scale of the relevant facility, and predicting a degree of influence of the target object on the target area by inputting the second data, a type of day of week, and time to a machine learning model which has been trained with three-dimensional first data, a type of day of week, and time as input, and with a degree of influence of the target object on the target area as output, the first data being obtained by superimposing the first matrix and the second matrix.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of input and output of a machine learning model;

FIG. 2A is a diagram illustrating map data according to the present embodiment;

FIG. 2B is a diagram illustrating an example of numerical value setting in consideration of the scale of a POI;

FIG. 3 is a diagram illustrating processing of an evaluation apparatus in a prediction phase;

FIG. 4 is a functional block diagram illustrating a configuration of an evaluation apparatus according to the present embodiment;

FIG. 5 is a diagram illustrating an example of a configuration of the machine learning model;

FIG. 6 is a diagram (1) illustrating processing of a preprocessing unit;

FIG. 7 is a diagram (2) illustrating processing of the preprocessing unit;

FIG. 8 is a flowchart illustrating a processing procedure of the evaluation apparatus according to the present embodiment;

FIG. 9 is a diagram illustrating a comparison result of the prediction accuracy of communication capacity;

FIG. 10 is a diagram illustrating other processing of the evaluation apparatus;

FIG. 11 is a diagram illustrating an example of prediction accuracy in a case where a target area is expanded;

FIG. 12 is a diagram illustrating an example of a hardware configuration of a computer that implements functions similar to those of the evaluation apparatus of the embodiment; and

FIG. 13 is a diagram illustrating a relationship between BS density and communication capacity obtained in related art.

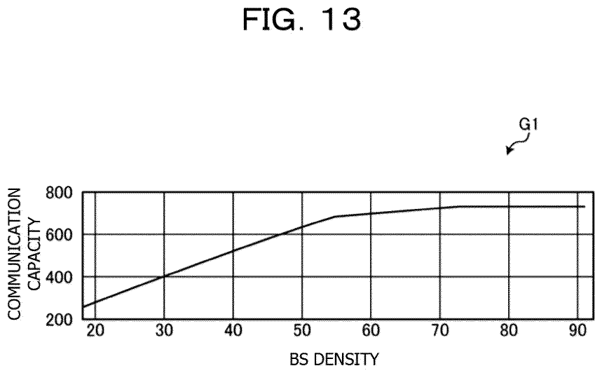

### DESCRIPTION OF EMBODIMENT

However, in the above-described related art, there is a problem that the degree of influence in consideration of a relative positional relationship between a facility in an area and a target object may not be predicted.

For example, in related art, while it is possible to estimate the number of BSs that satisfies a traffic demand, communication capacity in an area is not estimated by estimating the position of a BS and considering a relative positional relationship between a POI and the BS.

Such a problem is not limited to a BS, and may also occur in a similar manner for a target object providing a service according to the number and positions of users.

Hereinafter, an embodiment of an evaluation method and an information processing apparatus disclosed in the present application will be described in detail with reference to the drawings. This disclosure is not limited by this embodiment.

### Embodiment

An evaluation apparatus according to the present embodiment predicts the degree of influence in consideration of a relative positional relationship between a facility in a target area and a target object by using a convolutional neural network. In the present embodiment, as an example, description will be given with “POI” as a facility in a target area, and description will be given with “BS” as a target object. For example, a POI is a facility such as a library, park, bank, cafe, school, hospital, bar, restaurant, store, or subway station. Description will be given with “communication capacity” as the degree of influence in consideration of a relative positional relationship between a facility in a target area and a target object. A convolutional neural network is referred to as a “machine learning model”.

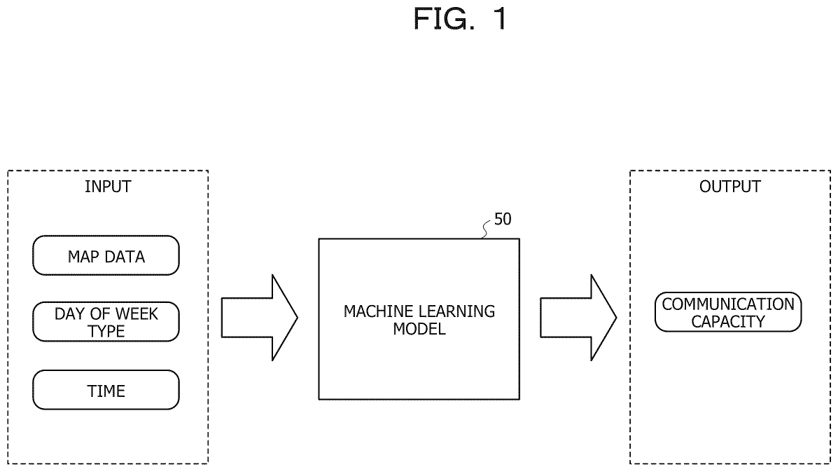

First, an example of input and output of a machine learning model used by the evaluation apparatus will be described. FIG. 1 is a diagram illustrating an example of the input and output of a machine learning model. As illustrated in FIG. 1, the input of a machine learning model 50 is map data, a day of week type, and time. The output of the machine learning model 50 is a communication capacity.

For example, the map data indicates the position of a POI in a target area and the position of a BS in the target area. “Weekday” or “holiday” is set as the day of week type. Time at every 30 minutes is set as the time. The communication capacity is the maximum value of communication capacity of a BS installed in the target area.

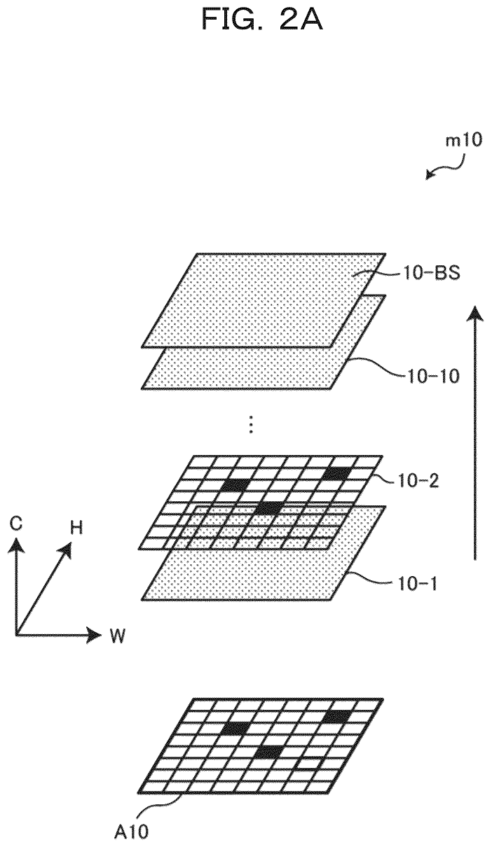

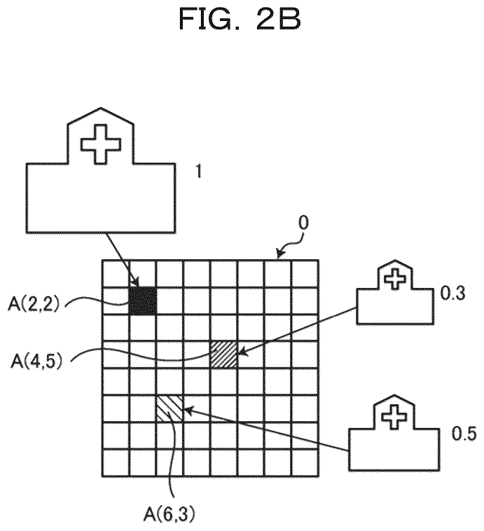

Map data will be described. FIG. 2A is a diagram illustrating map data according to the present embodiment. Map data is three-dimensional data of C×H×W. “C” indicates a channel of a POI or a BS, “H” indicates a position (latitude) of a target area in the vertical axis direction, and “W” indicates a position (longitude) of the target area in the horizontal axis direction. In map data, plane data is arranged for each channel.

The evaluation apparatus divides a target area and plane data into small areas. When there is a POI or BS corresponding to a channel in a small area of a target area, the evaluation apparatus sets “1” for the corresponding small area of plane data. When there is no POI or BS corresponding to a channel, the evaluation apparatus sets “0” for the corresponding small area.

For example, map data m10 illustrated in FIG. 2A is generated based on the facility position information of a target area A10. For example, facility position information is information in which a BS and a POI (type of POI) included in the target area A10 are associated with positions. The map data m10 includes plane data 10-1, 10-2, . . . , and 10-10 corresponding to each POI and plane data 10-BS corresponding to a BS. Illustration of the plane data 10-3 to 10-9 is omitted. The plane data 10-1 to 10-10 and 10-BS are divided into the same small areas as the target area A10. In the following description, among the small areas of the target area and the plane data 10-1 to 10-10 and 10-BS, the small area of the i-th row and the j-th column is denoted by (i, j).

The plane data 10-1 is plane data corresponding to the channel “library”. When a library is located in the small area (i, j) among the small areas of the target area A10, the evaluation apparatus sets “1” for the small area (i, j) of the plane data 10-1. When a library is not located in the small area (i, j) among the small areas of the target area A10, the evaluation apparatus sets “0” for the small area (i, j) of the plane data 10-1. The evaluation apparatus sets “1” or “0” for each small area of the plane data 10-1 by repeating the above-described processing while changing the values of i and j.

The plane data 10-2 is plane data corresponding to the channel “park”. When a park is located in the small area (i, j) among the small areas of the target area A10, the evaluation apparatus sets “1” for the small area (i, j) of the plane data 10-2. When a park is not located in the small area (i, j) among the small areas of the target area A10, the evaluation apparatus sets “0” for the small area (i, j) of the plane data 10-2. The evaluation apparatus sets “1” or “0” for each small area of the plane data 10-2 by repeating the above-described processing while changing the values of i and j.

The plane data 10-3 is plane data corresponding to the channel “bank”. The plane data 10-4 is plane data corresponding to the channel “cafe”. The plane data 10-5 is plane data corresponding to the channel “school”. The plane data 10-6 is plane data corresponding to the channel “hospital”. The plane data 10-7 is plane data corresponding to the channel “bar”. The plane data 10-8 is plane data corresponding to the channel “restaurant”. The plane data 10-9 is plane data corresponding to the channel “store”. The plane data 10-10 is plane data corresponding to the channel “subway station”.

Also for the plane data 10-3 to 10-10, the evaluation apparatus sets “1” or “0” for each small area based on the target area A10, similarly to the plane data 10-1 and 10-2.

The plane data 10-BS is plane data corresponding to the channel “BS”. When a BS is located in the small area (i, j) among the small areas of the target area A10, the evaluation apparatus sets “1” for the small area (i, j) of the plane data 10-BS. When a BS is not located in the small area (i, j) among the small areas of the target area A10, the evaluation apparatus sets “0” for the small area (i, j) of the plane data 10-BS. The evaluation apparatus sets “1” or “0” for each small area of the plane data 10-BS by repeating the above-described processing while changing the values of i and j.

In the above description, a case where the numerical value set for the small areas of the plane data 10-1 to 10-10 and 10-BS is “0” or “1” has been described. However, this is not the only case. For example, a continuous value of “0 to 1” may be set for a small area according to the scale of each POI set in a target area and the magnitude of the transmission power of a BS. As the scale of a POI is larger and as the transmission power of a BS is larger, the value is closer to “1”.

FIG. 2B is a diagram illustrating an example of numerical value setting in consideration of the scale of a POI. For example, when the site area of a POI (hospital) installed in the small area (2, 2) is equal to or larger than a first threshold, the evaluation apparatus sets the numerical value of the small area (2, 2) to “1”. When the site area of a POI installed in the small area (6, 3) is smaller than the first threshold and equal to or larger than a second threshold, the evaluation apparatus sets the numerical value of the small area (6, 3) to “0.5”. When the site area of a POI installed in the small area (4, 5) is smaller than the second threshold, the evaluation apparatus sets the numerical value of the small area (4, 5) to “0.3”. The above-described thresholds and numerical values corresponding to the thresholds are examples and may be changed as appropriate.

Next, processing of a training phase and processing of a prediction phase executed by the evaluation apparatus will be described.

First, the processing of the training phase executed by the evaluation apparatus will be described. In the training phase, the evaluation apparatus executes training of the machine learning model 50 by using a training data set. A plurality of pieces of training data is included in the training data set. A pair of input data and correct answer label is set in each piece of training data. Input data includes map data, a day of week type, and time. Communication capacity is set in a correct answer label.

The evaluation apparatus inputs input data to the machine learning model 50, and updates the parameters (machine learning) of the machine learning model 50 based on back propagation or the like such that the value output from the machine learning model 50 approaches a correct answer label.

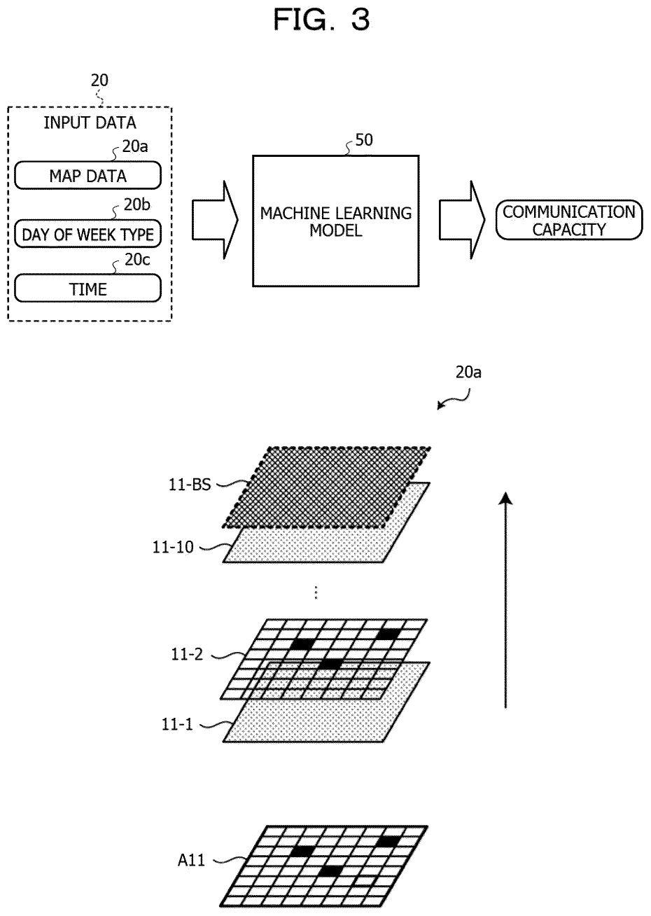

Next, the processing of the prediction phase executed by the evaluation apparatus will be described. FIG. 3 is a diagram illustrating processing of the evaluation apparatus in the prediction phase. In this diagram, a case where the evaluation apparatus predicts the communication capacity of a certain target area A11 will be described.

The evaluation apparatus generates input data 20. The input data 20 includes map data 20a, a day of week type 20b, and time 20c. As the day of week type 20b and the time 20c, day of week type and time to be evaluation targets are set by a user.

The map data 20a includes plane data 11-1, 11-2, . . . , and 11-10 and plane data 11-BS corresponding to a BS. Illustration of the plane data 11-3 to 11-9 is omitted.

The evaluation apparatus divides the target area A11 and the plane data 11-1 to 11-10 and 11-BS into small areas. Similarly to the processing described with reference to FIG. 2A, when there is a POI corresponding to a channel in a small area of the target area A11, the evaluation apparatus sets “1” for the corresponding small area of plane data, and when there is no POI corresponding to a channel, the evaluation apparatus sets “0” for the corresponding small area.

The evaluation apparatus sets arrangement information of BS to be evaluated for the plane data 11-BS. For example, in accordance with an instruction from a user, the evaluation apparatus sets “1” for a small area of the plane data 11-BS where a BS is arranged, and sets “0” for a small area where a BS is not arranged.

The evaluation apparatus may set “1” or “0” for each small area of the plane data 11-BS based on the small area of the target area A11 where a BS is actually installed. For example, when a BS is located in the small area (i, j) among the small areas of the target area A11, the evaluation apparatus sets “1” for the small area (i, j) of the plane data 11-BS. When a BS is not located in the small area (i, j) among the small areas of the target area A11, the evaluation apparatus sets “0” for the small area (i, j) of the plane data 11-BS. The evaluation apparatus sets an initial value of “1” or “0” for each small area of the plane data 11-BS by repeating the above-described processing while changing the values of i and j.

After an initial value is set for each small area of the plane data 11-BS as described above, the evaluation apparatus randomly changes “1” of one of the small areas to “0” or changes “0” of one of the small areas to “1”. Alternatively, after an initial value is set for each small area of the plane data 11-BS, the evaluation apparatus selects a small area adjacent to a small area for which “1” is set, changes the value of the small area for which “1” is set to “0”, and sets the value of the selected small area to “1”.

The evaluation apparatus generates the map data 20a by superimposing the above-described plane data 11-1 to 11-10 and plane data 11-BS.

The evaluation apparatus predicts a communication capacity by inputting input data including the map data 20a, the day of week type 20b, and the time 20c to the machine learning model 50 which has been trained. The evaluation apparatus determines whether the predicted communication capacity satisfies the traffic demand of the target area A11.

As described above, the evaluation apparatus according to the present embodiment predicts the communication capacity of a target area by inputting, to the machine learning model 50, map data in which plane data based on the position of a POI in the target area and plane data based on the position of a BS in the target area are superimposed, a day of week type, and time. Accordingly, the degree of influence in consideration of a relative positional relationship between a facility in a target area and a target object may be predicted.

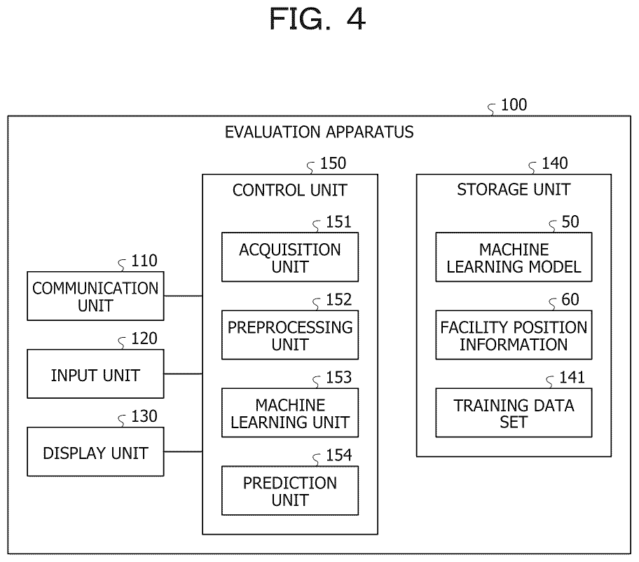

Next, description will be given for an example of a configuration of the evaluation apparatus that executes the processing described with reference to FIGS. 1 to 3. FIG. 4 is a functional block diagram illustrating the configuration of the evaluation apparatus according to the present embodiment. As illustrated in FIG. 4, an evaluation apparatus 100 includes a communication unit 110, an input unit 120, a display unit 130, a storage unit 140, and a control unit 150.

The communication unit 110 executes data communication with an external apparatus or the like via a network. The control unit 150 to be described later exchanges data with an external apparatus via the communication unit 110.

The input unit 120 is an input device that inputs various types of information to the control unit 150 of the evaluation apparatus 100. The input unit 120 corresponds to a keyboard, a mouse, a touch panel, or the like. A user operates the input unit 120 and sets a day of week type, time, and a value of map data.

The display unit 130 is a display device that displays information output from the control unit 150. For example, the display unit 130 displays a prediction result of communication capacity.

The storage unit 140 includes the machine learning model 50, facility position information 60, and a training data set 141. The storage unit 140 corresponds to a storage device such as a memory.

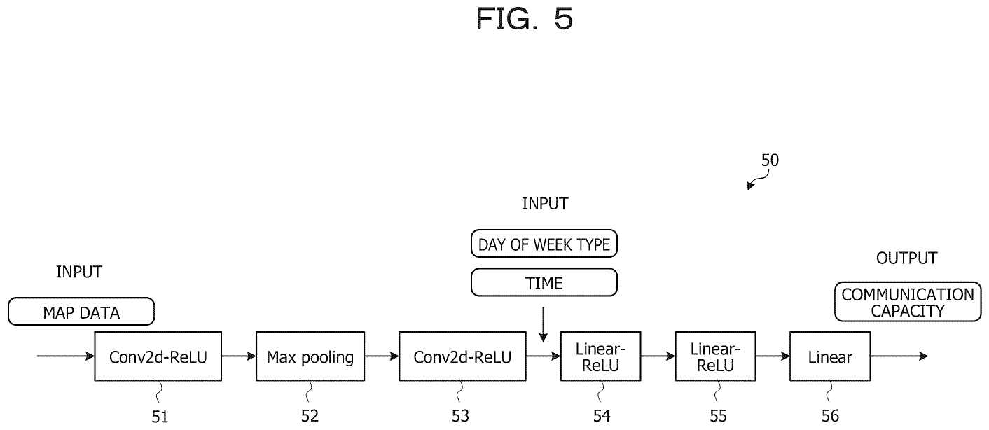

The machine learning model 50 is a convolutional neural network described with reference to FIG. 1 and the like. Here, an example of the configuration of the machine learning model will be described. FIG. 5 is a diagram illustrating an example of the configuration of the machine learning model. As illustrated in FIG. 5, this machine learning model 50 includes a Conv2d-ReLU layer 51, a Max pooling layer 52, a Conv2d-ReLU layer 53, a Linear-ReLU layer 54, a Linear-ReLU layer 55, and a Linear layer 56.

From input data, map data is input to the Conv2d-ReLU layer 51, and a day of week type and time are input to the Linear-ReLU layer 54.

When map data is input, the Conv2d-ReLU layer 51 executes convolution calculation and outputs a calculation result. The value output from the Conv2d-ReLU layer 51 is input to the Max pooling layer 52. For example, the number of output channels of the Conv2d-ReLU layer 51 is “16” and the kernel size thereof is “3”.

When the value is input, the Max pooling layer 52 executes maximum value pooling and outputs an execution result. The value output from the Max pooling layer 52 is input to the Conv2d-ReLU layer 53. For example, the kernel size of the Max pooling layer 52 is “2”.

When the value is input, the Conv2d-ReLU layer 53 executes convolution calculation and outputs a calculation result. The value output from the Conv2d-ReLU layer 53 is input to the Linear-ReLU layer 54. The number of output channels of the Conv2d-ReLU layer 53 is “32” and the kernel size thereof is “3”.

The value output from the Conv2d-ReLU layer 53 and a day of week type and time are input to the Linear-ReLU layer 54. When the value output from the Conv2d-ReLU layer 53 and a day of week type and time are input, the Linear-ReLU layer 54 performs calculation according to parameters and outputs a calculation result. The value output from the Linear-ReLU layer 54 is input to the Linear-ReLU layer 55. The number of nodes of the Linear-ReLU layer 54 is “300”.

When the value output from the Linear-ReLU layer 54 is input, the Linear-ReLU layer 55 performs calculation according to parameters and outputs a calculation result. The value output from the Linear-ReLU layer 55 is input to the Linear layer 56. The number of nodes of the Linear-ReLU layer 55 is “300”.

When the value output from the Linear-ReLU layer 55 is input, the Linear layer 56 performs calculation according to parameters and outputs a calculation result. The calculation result is a scalar that corresponds to communication capacity.

Returning to the description of FIG. 4, facility position information includes information related to the position and scale of each POI and the position and scale of each BS included in a predetermined area.

The training data set 141 includes a plurality of pieces of training data for executing training of the machine learning model 50. A pair of input data and correct answer label is set in each piece of training data. Input data includes map data, a day of week type, and time. Communication capacity is set in a correct answer label. The training data set 141 may be generated in advance or may be generated by a preprocessing unit 152 to be described later.

The control unit 150 includes an acquisition unit 151, the preprocessing unit 152, a machine learning unit 153, and a prediction unit 154. The control unit 150 is a central processing unit (CPU), a graphics processing unit (GPU), or the like.

The acquisition unit 151 acquires various types of data from an external apparatus or the like via a network. For example, the acquisition unit 151 acquires the facility position information 60 and registers the acquired facility position information 60 in the storage unit 140. The acquisition unit 151 may acquire the training data set 141 and register the training data set in the storage unit 140.

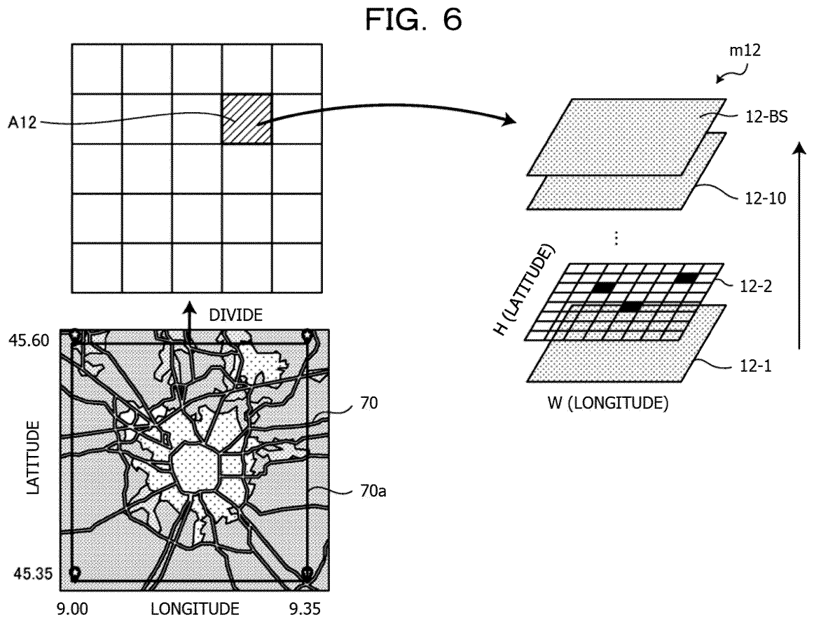

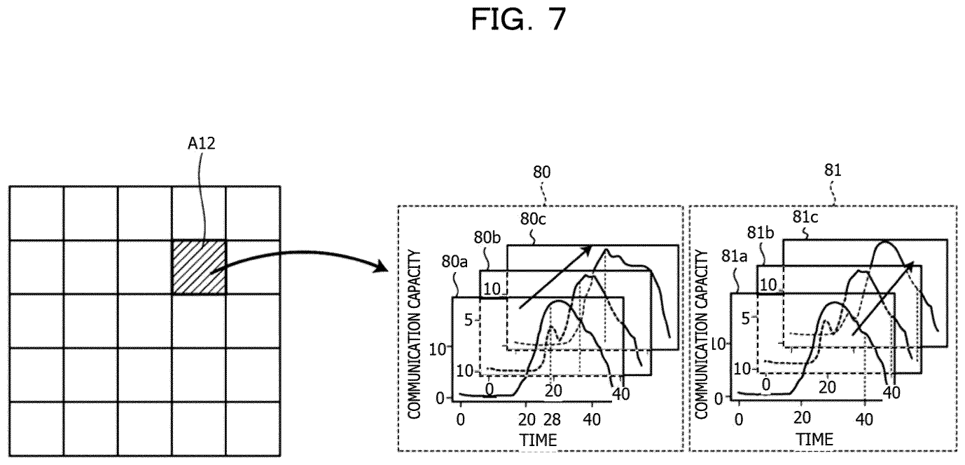

The preprocessing unit 152 generates the training data set 141 based on the facility position information 60. FIGS. 6 and 7 are diagrams illustrating processing of the preprocessing unit. First, description will be given for FIG. 6. For example, the preprocessing unit 152 causes a map 70 to be displayed on the display unit 130, and requests a user to designate a target region. The user refers to the map 70 displayed on the display unit, and operates the input unit 120 and selects a target region 70a.

When the designation of the target region 70a is received, the preprocessing unit 152 divides the target region 70a into a plurality of areas. For example, the preprocessing unit 152 generates a total of 10,000 areas by performing division by 100 in the vertical direction and division by 100 in the horizontal direction. In FIG. 6, only some of areas is displayed. The preprocessing unit 152 generates map data for each area by executing the following processing. For example, description will be given for a case in which the preprocessing unit 152 generates map data m12 based on an area (target area) A12.

The preprocessing unit 152 identifies the positions of a POI and a BS included in the target area A12 based on the facility position information 60 corresponding to the target area A12. The preprocessing unit 152 generates plane data 12-1 to 12-10 and 12-BS based on the result of identification. The processing in which the preprocessing unit 152 generates the plane data 12-1 to 12-10 and 12-BS based on the target area A12 is similar to the processing of generating the plane data 10-1 to 10-10 and 10-BS from the target area A10 described with reference to FIG. 2. The preprocessing unit 152 generates the map data m12 by superimposing the plane data 12-1 to 12-10 and 12-BS.

The preprocessing unit 152 prepares preset day of week type and time. The two types of preset day of week type are “weekday” and “holiday”. As the preset time, 0 to 48 are assigned to every 30 minutes in a period of 0:00 to 24:00. For example, “0” is assigned to 0:00 and “1” is assigned to 0:30. The preprocessing unit 152 generates a combination of the map data m12, each day of week type, and each time as input data of training data. For example, the number of pieces of input data of the target area A12 is 96.

Moving on to the description of FIG. 7, by executing the processing of FIG. 7, the preprocessing unit 152 identifies a correct answer label (communication capacity) that is a correct answer label of training data and that is paired with the input data of the target area A12.

The preprocessing unit 152 acquires, from an external apparatus or the like, an actual value set of communication capacity of the target area A12 in a predetermined period. FIG. 7 illustrates actual value sets 80 and 81 as examples. The actual value set 80 is an actual value set for the day of week type “weekday” of the target area A12. The actual value set 80 includes pieces of actual value information 80a, 80b, and 80c for respective dates in a predetermined period. The vertical axis of the pieces of actual value information 80a, 80b, and 80c indicates actual value of communication capacity, and the horizontal axis thereof corresponds to time. Numerical values on the horizontal axis are values obtained by assigning numerical values of 0 to 48 to 0:00 to 24:00 (time in increments of 30 minutes).

The actual value set 81 is an actual value set for the day of week type “holiday” of the target area A12. The actual value set 81 includes pieces of actual value information 81a, 81b, and 81c for respective dates in a predetermined period. The vertical axis of the pieces of actual value information 81a, 81b, and 81c indicates actual value of communication capacity, and the horizontal axis thereof corresponds to time. Numerical values on the horizontal axis are values obtained by assigning numerical values of 0 to 48 to 0:00 to 24:00 (time in increments of 30 minutes).

Assume that the day of week type of input data is “weekday” and the time thereof is “14:00 (28)”. In this case, the preprocessing unit 152 identifies the maximum communication capacity (19 Mbps) among the communication capacities corresponding to the time “28” of the pieces of actual value information 80a, 80b, and 80c included in the actual value set 80. The preprocessing unit 152 sets the identified communication capacity (19 Mbps) as the correct answer label corresponding to the input data of training data “map data m12, day of week type “weekday”, and time “28””, and registers the training data of the input data and the correct answer label in the training data set.

On the other hand, assume that the day of week type of input data is “holiday” and the time thereof is “20:00 (40)”. In this case, the preprocessing unit 152 identifies the maximum communication capacity (11 Mbps) among the communication capacities corresponding to the time “40” of the pieces of actual value information 81a, 81b, and 81c included in the actual value set 81. The preprocessing unit 152 sets the identified communication capacity (11 Mbps) as the correct answer label corresponding to the input data of training data “map data m12, day of week type “holiday”, and time “40””, and registers the training data of the input data and the correct answer label in the training data set.

By repeatedly executing the above-described processing on each piece of input data of the target area A12, the preprocessing unit 152 generates a plurality of pieces of training data related to the target area A12, and registers the plurality of pieces of training data in the training data set 141.

Also for each target area illustrated in FIG. 6, by repeatedly executing the above-described processing, the preprocessing unit 152 generates a plurality of pieces of training data related to each target area, and registers the plurality of pieces of training data in the training data set 141.

Returning to the description of FIG. 4, in the training phase, the machine learning unit 153 executes training of the machine learning model 50 based on the training data set 141. The machine learning unit 153 acquires training data from the training data set 141, and inputs the input data of the training data (map data, day of week type, and time) to the machine learning model 50. The machine learning unit 153 updates the parameters of the machine learning model 50 based on back propagation or the like such that the value output from the machine learning model 50 approaches the correct answer label of the training data. The machine learning unit 153 repeatedly executes the above-described processing.

In the prediction phase, the prediction unit 154 predicts the communication capacity of a target area. For example, a user operates the input unit 120 and designates a target area, a day of week type, and time. The prediction unit 154 generates map data based on the facility position information 60 of the target area designated by the user. The processing in which the prediction unit 154 generates map data of a target area is similar to the processing of generating the map data 20a from the target area A11 described with reference to FIG. 3.

The prediction unit 154 obtains a communication capacity by inputting input data including the map data, the day of week type, and the time to the machine learning model 50 which has been trained. The prediction unit 154 determines whether the communication capacity is equal to or larger than a predetermined traffic demand, and outputs a determination result to the display unit 130.

When the communication capacity is smaller than the predetermined traffic demand, the prediction unit 154 updates the plane data of BS included in the map data and updates the input data. The prediction unit 154 obtains a communication capacity by inputting the updated input data to the machine learning model 50. The prediction unit 154 repeatedly executes update of the input data until the communication capacity is equal to or larger than the predetermined traffic demand.

In the case of updating the plane data of BS included in the map data, the prediction unit 154 randomly changes “1” of one of the small areas to “0” (reduces the number of BSs) or changes “0” of one of the small areas to “1” (increases the number of BSs) in the plane data of BS. Alternatively, the prediction unit 154 selects a small area adjacent to a small area for which “1” is set from among the small areas of the plane data, changes the value of the small area for which “1” is set to “0”, and sets the value of the selected small area to “1”.

The prediction unit 154 may repeat the above-described processing and execute processing of searching for such plane data of BS that the communication capacity is equal to or larger than the predetermined traffic demand and the number of BSs is minimized. The prediction unit 154 may execute the processing of searching for such plane data of BS that the communication capacity is equal to or larger than the predetermined traffic demand and the number of BSs is minimized, for all combinations of the day of week type and time of a target area. For example, the prediction unit 154 may execute the processing of searching for plane data of BS by setting an objective function that minimizes the number of BSs and a constraint condition in which the communication capacity is equal to or larger than a threshold for all combinations of the day of week type and time.

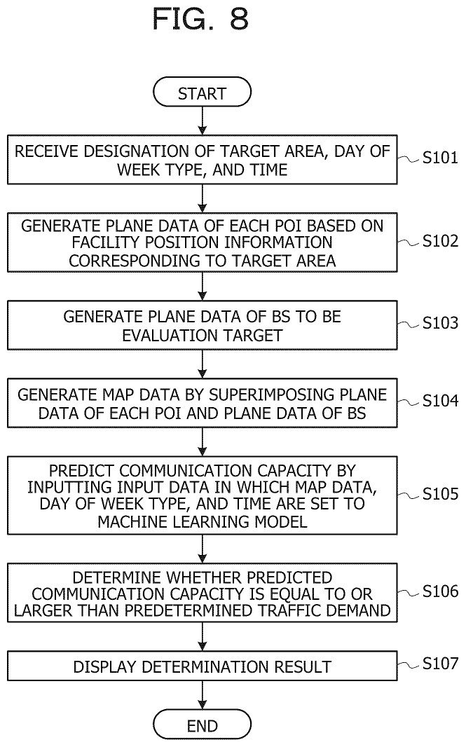

Next, an example of a processing procedure of the evaluation apparatus according to the present embodiment will be described. FIG. 8 is a flowchart illustrating a processing procedure of the evaluation apparatus according to the present embodiment. The machine learning model 50 used in the processing of FIG. 8 is a machine learning model which has been trained through the training phase. As illustrated in FIG. 8, the prediction unit 154 of the evaluation apparatus 100 receives designation of a target area, a day of week type, and time from the input unit 120 (step S101).

The prediction unit 154 generates plane data of each POI based on the facility position information 60 corresponding to the target area (step S102). The prediction unit 154 generates plane data of a BS to be an evaluation target (step S103). The prediction unit 154 generates map data by superimposing the plane data of each POI and the plane data of BS (step S104).

The prediction unit 154 predicts a communication capacity by inputting input data in which the map data, day of week type, and time are set to the machine learning model 50 (step S105). The prediction unit 154 determines whether the predicted communication capacity is equal to or larger than a predetermined traffic demand (step S106). The prediction unit 154 causes a determination result to be displayed on the display unit 130 (step S107).

Next, the effects achieved by the evaluation apparatus 100 according to the present embodiment will be described. The evaluation apparatus 100 according to the present embodiment uses a machine learning model in which map data, a day of week type, and time are the input and the degree of influence of a target object is the output. Map data is three-dimensional data in which two-dimensional plane data indicating a position and a scale provided for each POI already arranged in a target area and two-dimensional plane data indicating the position and scale of a target object in the target area are superimposed. The evaluation apparatus 100 predicts the degree of influence on a target area by inputting, to the machine learning model 50 which has been trained, map data in which plane data for each POI and plane data related to the arrangement and scale of a target object of an evaluation target are superimposed, a day of week type, and time. Accordingly, the degree of influence in consideration of a relative positional relationship between a facility in an area and a target object may be predicted.

For example, the evaluation apparatus 100 may predict the communication capacity in consideration of a relative positional relationship between a POI in a target area and a base station, with the base station as a target object and the communication capacity resulting from BS arrangement in the target area as the degree of influence of the target object.

The evaluation apparatus 100 executes training of the machine learning model 50 by using training data in which input data including map data, a day of week type, and time is associated with a correct answer label of communication capacity. Accordingly, the communication capacity of a target area may be predicted by inputting the map data, day of week type, and time to the machine learning model 50.

The evaluation apparatus 100 may predict whether arranged BSs may satisfy the traffic demand of a target area by comparing the predicted communication capacity with the traffic demand of the target area.

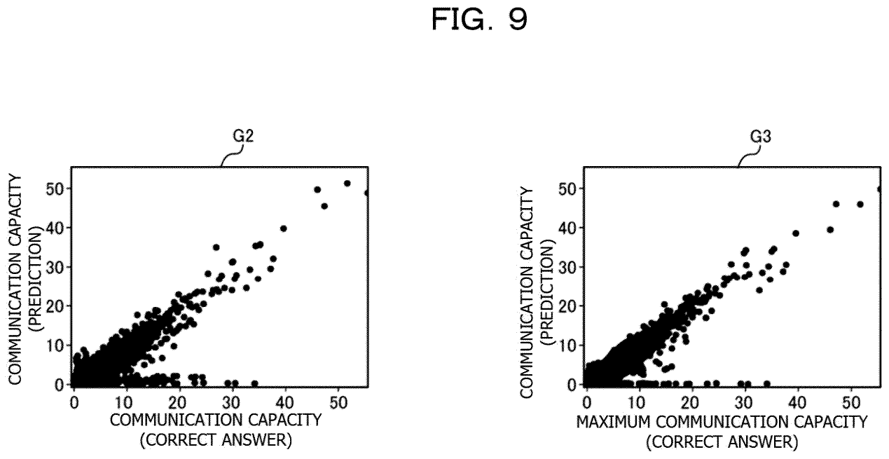

The evaluation apparatus 100 may predict the communication capacity more accurately compared to related art by predicting the communication capacity using the machine learning model 50. FIG. 9 is a diagram illustrating a comparison result of the prediction accuracy of communication capacity. Graph G2 of FIG. 9 is a graph illustrating the accuracy of communication capacity in related art. Graph G3 is a graph illustrating the accuracy of communication capacity of the evaluation apparatus 100. The vertical axis of graphs G2 and G3 indicates communication capacity (prediction), and the horizontal axis thereof indicates communication capacity (correct answer).

In graph G2, decision variable is “0.82” and average error is “0.61”. In graph G3, decision variable is “0.91” and average error is “0.41”. The prediction accuracy of communication capacity is better as decision variable approaches “1” and as average error approaches 0. For example, it is indicated that the prediction accuracy of the evaluation apparatus 100 according to the present embodiment is better than the prediction accuracy in related art.

By the way, the processing of the evaluation apparatus 100 described above is an example, and the evaluation apparatus 100 may execute other processing. For example, there is a case in which the communication capacity is large due to the fact that, although there are few POIs in a target area, POIs densely concentrate in an adjacent area or there is a large-scale POI in the adjacent area. In this case, when setting a target area, the evaluation apparatus 100 adjusts the size of the target area such that one or more certain POIs are included.

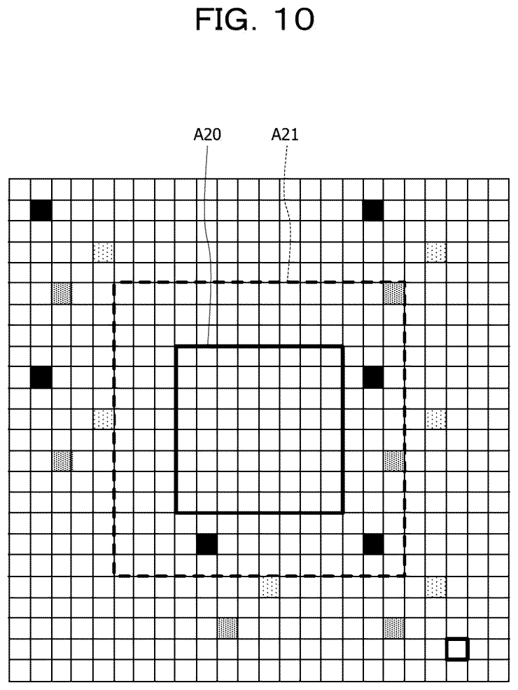

FIG. 10 is a diagram illustrating other processing of the evaluation apparatus. For example, A20 is an initial target area. There are no POIs in the target area A20. In such a case, the evaluation apparatus 100 expands the target area A20 to a target area A21 and causes any of the POIs to be included. As the POI to be at least included in the target area, the evaluation apparatus 100 selects a POI in which pieces of UE are likely to be concentrated according to regional characteristics. The evaluation apparatus 100 may also reduce the calculation load by narrowing down the POIs to be considered based on the importance thereof or the like. The importance of a POI according to each regional characteristic is set in advance.

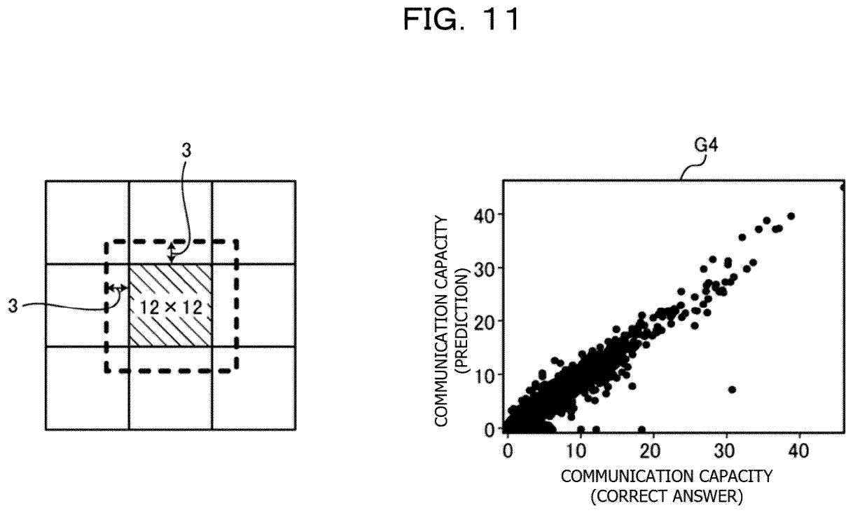

FIG. 11 is a diagram illustrating an example of the prediction accuracy in a case where a target area is expanded. In this example, a target area is expanded by three cells around an initial target area of 12×12 cells. When the evaluation apparatus 100 sets a target area by such a method and predicts the communication capacity by using the machine learning model 50, graph G4 is obtained as the graph illustrating the accuracy of communication capacity. The vertical axis of graph G4 indicates communication capacity (prediction), and the horizontal axis thereof indicates communication capacity (correct answer). In graph G4, decision variable is “0.96” and average error is “0.29”. This indicates that the accuracy of communication capacity is improved since decision variable is closer to 1 and average error is reduced compared to graph G2.

In the present embodiment, although description has been given with “BS” as a target object and description has been given with “communication capacity” as the degree of influence in consideration of a relative positional relationship between a facility in a target area and a target object, these are not the only cases. A target object may be a target object providing a service according to the number and positions of users (a restaurant, a convenience store, a supermarket, a vending machine, or a taxi). The degree of influence in consideration of a relative positional relationship between a facility in a target area and a target object may be sales amount, service quality, or the like.

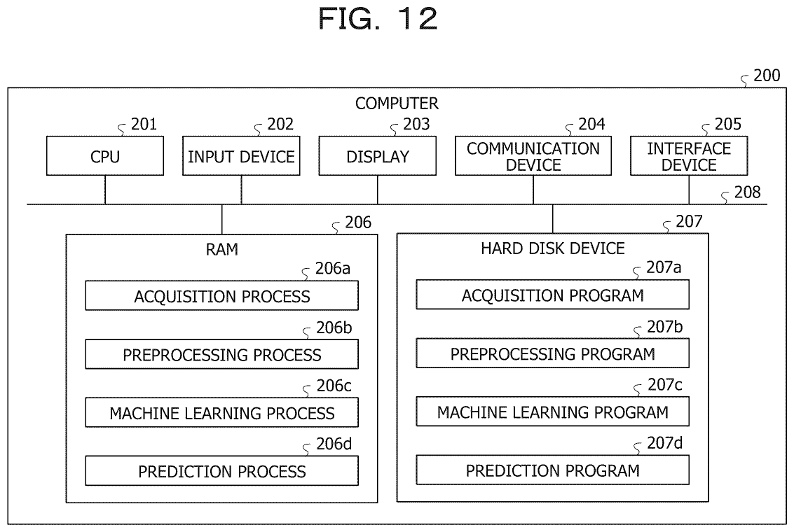

Next, description will be given for an example of a hardware configuration of a computer that implements functions similar to those of the evaluation apparatus 100 described above. FIG. 12 is a diagram illustrating an example of the hardware configuration of a computer (information processing apparatus) that implements functions similar to those of the evaluation apparatus of the embodiment.

As illustrated in FIG. 12, a computer 200 includes a CPU 201 that executes various types of arithmetic processing, an input device 202 that receives input of data from a user, and a display 203. The computer 200 includes a communication device 204 that exchanges data with an external apparatus or the like via a wired or wireless network, and an interface device 205. The computer 200 includes a random-access memory (RAM) 206 that temporarily stores various types of information and a hard disk device 207. Each of the devices 201 to 207 is coupled to a bus 208.

The hard disk device 207 includes an acquisition program 207a, a preprocessing program 207b, a machine learning program 207c, and a prediction program 207d. The CPU 201 reads each of the programs 207a to 207d and loads the programs to the RAM 206.

The acquisition program 207a functions as an acquisition process 206a. The preprocessing program 207b functions as a preprocessing process 206b. The machine learning program 207c functions as a machine learning process 206c. The prediction program 207d functions as a prediction process 206d.

Processing of the acquisition process 206a corresponds to the processing of the acquisition unit 151. Processing of the preprocessing process 206b corresponds to the processing of the preprocessing unit 152. Processing of the machine learning process 206c corresponds to the processing of the machine learning unit 153. Processing of the prediction process 206d corresponds to the processing of the prediction unit 154.

Each of the programs 207a to 207d does not have to be stored in the hard disk device 207 in advance. For example, each program may be stored in a “portable physical medium” such as a flexible disk (FD), a compact disk read-only memory (CD-ROM), a Digital Versatile Disc (DVD), a magneto-optical disk, or an integrated circuit (IC) card, which is inserted in the computer 200. The computer 200 may read and execute each of the programs 207a to 207d.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
obtaining a third matrix by changing at least one of a position of a target object already installed in a target area or a scale of the target object in a two-dimensional second matrix that indicates the position of the target object and the scale of the target object;
obtaining three-dimensional second data by superimposing a two-dimensional first matrix and the third matrix, the first matrix being provided for each facility already installed in the target area and indicating a position of a relevant facility and a scale of the relevant facility; and
predicting a degree of influence of the target object on the target area by inputting the second data, a type of day of week, and time to a machine learning model which has been trained with three-dimensional first data, a type of day of week, and time as input, and with a degree of influence of the target object on the target area as output, the first data being obtained by superimposing the first matrix and the second matrix.

2. The non-transitory computer-readable recording medium according to claim 1, the process further comprising:
executing training of the machine learning model, based on training data in which input data includes the first data, the type of day of week, and the time and in which a degree of influence of the target object on the target area is a correct answer label.

3. The non-transitory computer-readable recording medium according to claim 2, the process further comprising:
in a case where no facility is included in the target area, expanding a range of the target area of the first matrix until a facility is included; and
executing training of the machine learning model by using training data in which input data includes three-dimensional data obtained by superimposing the first matrix in which the range of the target area is expanded and the second matrix.

4. The non-transitory computer-readable recording medium according to claim 3, wherein
the target object is a base station, and
the correct answer label includes communication capacity of the base station.

5. The non-transitory computer-readable recording medium according to claim 4, the process further comprising:
obtaining the third matrix by changing at least one of a position of the base station or a scale of the base station in the second matrix; and
predicting communication capacity of the base station by inputting the second data, a type of day of week, and time to the machine learning model.

6. The non-transitory computer-readable recording medium according to claim 5, the process further comprising:
determining, based on the predicted communication capacity and a demand for communication capacity of the target area, whether the demand for communication capacity of the target area is satisfied.

7. An evaluation method, comprising:
obtaining, by a computer, a third matrix by changing at least one of a position of a target object already installed in a target area or a scale of the target object in a two-dimensional second matrix that indicates the position of the target object and the scale of the target object;
obtaining three-dimensional second data by superimposing a two-dimensional first matrix and the third matrix, the first matrix being provided for each facility already installed in the target area and indicating a position of a relevant facility and a scale of the relevant facility; and
predicting a degree of influence of the target object on the target area by inputting the second data, a type of day of week, and time to a machine learning model which has been trained with three-dimensional first data, a type of day of week, and time as input, and with a degree of influence of the target object on the target area as output, the first data being obtained by superimposing the first matrix and the second matrix.

8. The evaluation method according to claim 7, further comprising:
executing training of the machine learning model, based on training data in which input data includes the first data, the type of day of week, and the time and in which a degree of influence of the target object on the target area is a correct answer label.

9. The evaluation method according to claim 8, further comprising:
in a case where no facility is included in the target area, expanding a range of the target area of the first matrix until a facility is included; and
executing training of the machine learning model by using training data in which input data includes three-dimensional data obtained by superimposing the first matrix in which the range of the target area is expanded and the second matrix.

10. The evaluation method according to claim 9, wherein
the target object is a base station, and
the correct answer label includes communication capacity of the base station.

11. The evaluation method according to claim 10, further comprising:
obtaining the third matrix by changing at least one of a position of the base station or a scale of the base station in the second matrix; and
predicting communication capacity of the base station by inputting the second data, a type of day of week, and time to the machine learning model.

12. The evaluation method according to claim 11, further comprising:
determining, based on the predicted communication capacity and a demand for communication capacity of the target area, whether the demand for communication capacity of the target area is satisfied.

13. An information processing apparatus, comprising:
a memory; and
a processor coupled to the memory and the processor configured to:
predict a degree of influence of a target object on a target area by inputting three-dimensional second data, a type of day of week, and time to a machine learning model which has been trained with three-dimensional first data, a type of day of week, and time as input, and with a degree of influence of the target object on the target area as output, the target object being already installed in the target area, the first data being obtained by superimposing a two-dimensional first matrix and a two-dimensional second matrix that indicates a position of the target object in the target area and a scale of the target object, the first matrix being provided for each facility already installed in the target area and indicating a position of a relevant facility and a scale of the relevant facility, the second data being obtained by superimposing the first matrix and a third matrix obtained by changing at least one of the position of the target object or the scale of the target object in the second matrix.

14. The information processing apparatus according to claim 13, wherein
the processor is configured to:
execute training of the machine learning model, based on training data in which input data includes the first data, the type of day of week, and the time and in which a degree of influence of the target object on the target area is a correct answer label.

15. The information processing apparatus according to claim 14, wherein
the processor is configured to:
in a case where no facility is included in the target area, expand a range of the target area of the first matrix until a facility is included; and
execute training of the machine learning model by using training data in which input data includes three-dimensional data obtained by superimposing the first matrix in which the range of the target area is expanded and the second matrix.

16. The information processing apparatus according to claim 15, wherein
the target object is a base station, and
the correct answer label includes communication capacity of the base station.

17. The information processing apparatus according to claim 16, wherein
the processor is configured to:
obtain the third matrix by changing at least one of a position of the base station or a scale of the base station in the second matrix; and
predict communication capacity of the base station by inputting the second data, a type of day of week, and time to the machine learning model.

18. The information processing apparatus according to claim 17, wherein
the processor is configured to:
determine, based on the predicted communication capacity and a demand for communication capacity of the target area, whether the demand for communication capacity of the target area is satisfied.
